(19) United States
(12) Patent Application Publication
(10) Pub. No.: US 2026/0062012 A1
(43) Pub. Date: Mar. 5, 2026

(54) VEHICLE CONTROL DEVICE AND VEHICLE CONTROL METHOD

(71) Applicant: DENSO CORPORATION, Kariya-city (JP)

(72) Inventors: Yusuke KANI, Kariya-city (JP); Yasuaki KURITA, Kariya-city (JP)

(21) Appl. No.: 19/386,794

(22) Filed: Nov. 12, 2025

Related U.S. Application Data
(63) Continuation of application No. PCT/JP2024/017688, filed on May 13, 2024.

(30) Foreign Application Priority Data
May 15, 2023 (JP) 2023-080018

(51) Int. Cl. B60W 50/00; G07C 5/00; G07C 5/10

(52) U.S. Cl. CPC B60W 50/0097; G07C 5/008; G07C 5/10

(57) ABSTRACT

A vehicle control device includes an API unit, which has multiple function APIs. The multiple function APIs are interfaces to respectively implement multiple functions using vehicle equipment. Each function API receives a request from an application and provides corresponding function using the vehicle equipment. The vehicle control device predicts a state of resource of the vehicle for a specified time period, and generates, for each function API, reference information, which includes a time period during which the corresponding function API can be used based on the prediction result. The vehicle control device provides the reference information to the function API specified in the request from the application.

### CROSS REFERENCE TO RELATED APPLICATIONS

The present application is a continuation application of International Patent Application No. PCT/JP2024/017688 filed on May 13, 2024, which designated the U.S. and claims the benefit of priority from Japanese Patent Application No. 2023-080018 filed on May 15, 2023. The entire disclosures of all of the above applications are incorporated herein by reference.

### TECHNICAL FIELD

The present disclosure relates to a technology for processing a request from application software that provides a service using a vehicle function.

### BACKGROUND

Conventionally, a vehicle data collection system collects information only under a situation specified by a server for effectively use the system resource. The data collection system is configured to collect, from multiple vehicles, various vehicle data detected by sensors mounted on the vehicles.

### SUMMARY

According to an aspect of the present disclosure, a vehicle control device, which is mounted on a vehicle, includes at least one processor with a memory storing computer program code. The at least one processor with the memory is configured to implement an equipment management unit, an application programming interface (API) unit, a state prediction unit, an information generation unit, and an information providing unit. The equipment management unit is configured to control vehicle equipment, which is equipped to the vehicle, and manage a state of the vehicle equipment. The application programming interface (API) unit has multiple function APIs, which are interfaces to respectively implement multiple functions using the vehicle equipment. Each function API receives a request transmitted from an application software and provides the corresponding function using the vehicle equipment that is managed by the equipment management unit. The state prediction unit may be configured to predict a state of resource included in the vehicle for a specified time period. The information generation unit may be configured to generate, for each function API, reference information, which includes a time period during which the corresponding function API can be used, based on a prediction result by the state prediction unit. The information providing unit may be configured to provide the reference information generated by the information generation unit to the function API specified in the request transmitted from the application software.

### BRIEF DESCRIPTION OF DRAWINGS

The present disclosure will become apparent from the following detailed description made with reference to the accompanying drawings. In the drawings:

FIG. 1 is a block diagram showing a configuration of a vehicle control system;

FIG. 2 is a block diagram showing a configuration of an ECU;

FIG. 3 is a block diagram showing a configuration of a center;

FIG. 4 is a block diagram showing a functional configuration of the vehicle control system;

FIG. 5 is an explanatory diagram showing an example of contents of required resource information;

FIG. 6 is a flowchart showing a process executed by a reservation arbitration unit;

FIG. 7 is a sequence diagram showing a basic process when a request is received via a confirmation API and a reservation API; and

FIG. 8 is a sequence diagram showing a process when a reservation competition occurs.

### DETAILED DESCRIPTION

In the future, with the spread of vehicle APIs, multiple systems may access the same vehicle. The vehicle API is an interface for providing vehicle functions to application software implemented inside or outside the vehicle.

When multiple systems exist inside and outside a vehicle and application software is executed in each system, each system accesses the vehicle at its own predetermined timing. Thus, a competition may occur when multiple systems access to the same vehicle. In the conventional technology, the processing load is controlled in a single system. Thus, with the conventional technology, it is unable to control the processing load when a competition occurs with other systems.

One aspect of the present disclosure is to provide a vehicle control device mounted on a vehicle. The vehicle control device includes an equipment management unit, an API unit, a state prediction unit, an information generation unit, and an information providing unit. The equipment management unit is configured to control vehicle equipment, which is equipped to the vehicle, and manage a state of the vehicle equipment. The API unit has multiple function APIs. The multiple function APIs are interfaces to respectively implement multiple functions using the vehicle equipment, and each function API receives a request transmitted from an application software and provides the corresponding function using the vehicle equipment that is managed by the equipment management unit. The state prediction unit is configured to predict a state of resource included in the vehicle for a specified time period. The information generation unit is configured to generate, for each function API, reference information, which includes a time period during which the corresponding function API can be used, based on a prediction result by the state prediction unit. The information providing unit is configured to provide the reference information generated by the information generation unit to the function API specified in the request transmitted from the application software.

According to the above vehicle control device, the application software can specify, via the information providing unit, the available period of required function API. Each application software uses the function API according to the specified available period. Thus, it is possible to prevent competition when multiple requests are output from multiple pieces of application software to use the same resource. That is, access requests to the same vehicle function from multiple pieces of application software can be controlled by suppressing an occurrence of insufficiency in vehicle resource. According to the above vehicle control device, when a competition occurs among multiple requests from multiple systems for accessing the same vehicle function, the multiple access request can be properly controlled.

One aspect of the present disclosure is to provide a vehicle control method executed by a computer included in a vehicle. The vehicle control method includes implementing, by the computer, an equipment management unit configured to control vehicle equipment, which is equipped to the vehicle, and manage a state of the vehicle equipment. The vehicle control method includes implementing, by the computer, an API unit having multiple function APIs. The multiple function APIs are interfaces to respectively implement multiple functions using the vehicle equipment, and each function API receives a request transmitted from an application software and provides the corresponding function using the vehicle equipment that is managed by the equipment management unit. The vehicle control method includes implementing, by the computer, a state prediction unit configured to predict a state of resource included in the vehicle for a specified time period. The vehicle control method includes implementing, by the computer, an information generation unit configured to generate, for each function API, reference information, which includes a time period during which the corresponding function API can be used, based on a prediction result by the state prediction unit. The vehicle control method includes implementing, by the computer, an information providing unit configured to provide the reference information generated by the information generation unit to the function API specified in the request transmitted from the application software.

According to the above vehicle control method, it is possible to provide the same effects as those of the above-mentioned vehicle control device.

Hereinafter, embodiments of the present disclosure will be described with reference to the drawings.

### 1. System Configuration

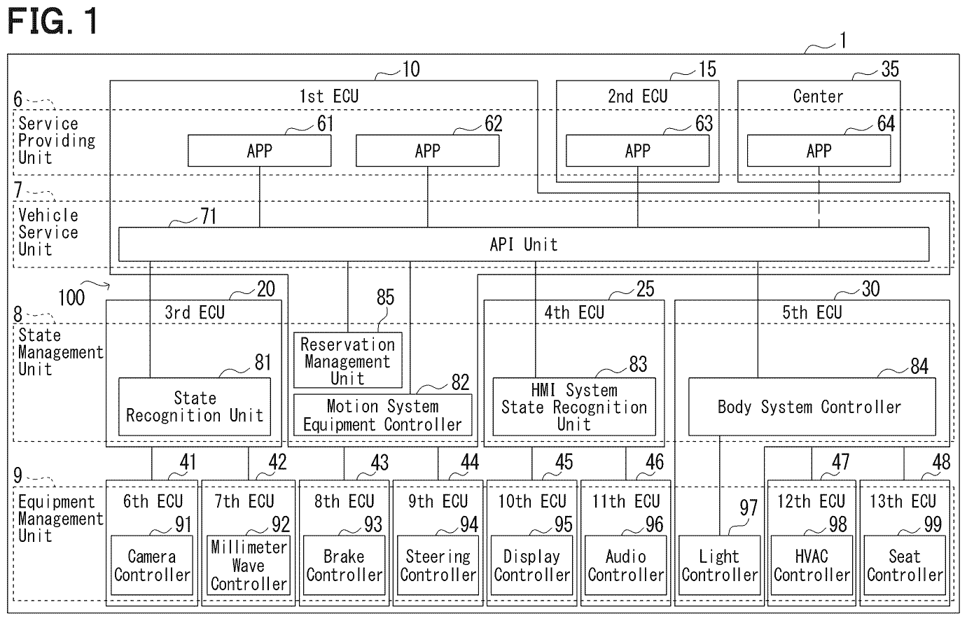

The vehicle control system 1 shown in FIG. 1 includes an electronic control unit (hereinafter referred to as ECU) group 100 mounted on a vehicle such as an automobile. The vehicle control system 1 further includes a center 35. The ECU group 100 includes multiple ECUs. In the present embodiment, the ECU group 100 includes a first ECU 10, a second ECU 15, a third ECU 20, a fourth ECU 25, a fifth ECU 30, and sixth to thirteenth ECUs 41 to 48. The ECUs included in the ECU group 100 are communicably connected to each other via internal vehicle communication (that is, wired communication or wireless communication). The center 35 is provided outside the vehicle and is connected to the ECU group 100 via external vehicle communication (that is, wireless communication).

The first ECU 10 has a relay function for the internal vehicle communication, and controls the second to fifth ECUs 15, 20, 25, 30, thereby performing coordinated control of the entire vehicle. The first ECU 10 also controls communication with the center 35, thereby performing coordinated control of the entire system including the center 35.

The first ECU 10 and the third to fifth ECUs 20, 25, 30 are provided for each of multiple domains, which are divided according to the functions of vehicle in the vehicle. The first ECU 10 and the third to fifth ECUs 20, 25, 30 each mainly performs control of multiple ECUs (that is, the sixth to thirteenth ECUs 41-48) included in the same domain. The multiple domains include, for example, a powertrain, a body, a chassis, a cockpit, or the like.

The sixth to thirteenth ECUs 41 to 48 each controls a vehicle equipment that is an equipment mounted on the vehicle.

The vehicle equipment may include hardware, such as sensors and actuators, as well as various storage devices for storing data and software for implementing certain functions.

The first ECU 10 and the third to fifth ECUs 20, 25, 30 each is connected, via lower layer network, for example, CAN to the lower layer ECUs, which are partial of the sixth to thirteenth ECUs 41 to 48. The CAN is a registered trademark and is an abbreviation for Controller Area Network. The first ECU 10 and the third to fifth ECUs 20, 25, 30 each has a function of centrally managing access rights to the corresponding lower layer ECUs, which is a part of the sixth to thirteenth ECUs 41 to 48, thereby performing user authentication.

In another embodiment, the vehicle control system 1 may include the ECU group 100, and does not include the center 35. In another embodiment, the number of ECUs included in the ECU group 100 may be 14 or more, or 13 or less. In another embodiment, the vehicle control system may include multiple centers 35.

### 2. Hardware Configuration

The following will describe a hardware configuration of each ECU included in the ECU group 100 and a hardware configuration of the center 35. Each ECU included in the ECU group 100 has the same hardware configuration. Accordingly, a configuration of the first ECU 10 will be described below as a representative.

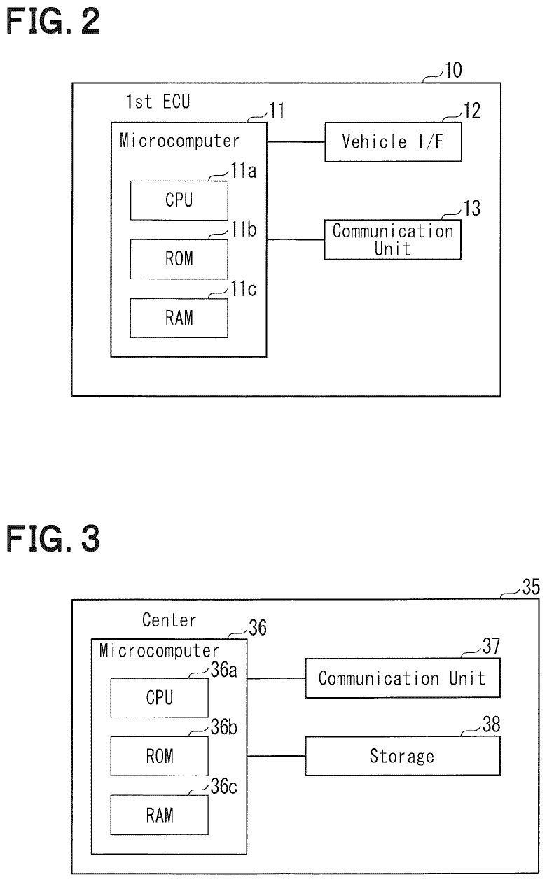

As shown in FIG. 2, the first ECU 10 includes a microcomputer 11, a vehicle interface (hereinafter, referred to as I/F) 12, and a communication unit 13. The microcomputer 11 includes a CPU 11a, a ROM 11b, and a RAM 11c. Various functions of the first ECU 10 are implemented by the CPU 11a executing a program stored in a non-transitory tangible storage medium. In the present embodiment, the ROM 11b corresponds to a non-transitory tangible storage medium that stores the program. A method corresponding to the program is performed when the program is executed.

The vehicle I/F 12 is connected to other ECUs and vehicle-mounted devices via a vehicle network or the like, and acquires various information from other ECUs and vehicle-mounted devices. The in-vehicle network may include a Controller Area Network (hereinafter, CAN) and Ethernet. CAN is a registered trademark. Ethernet is a registered trademark.

The communication unit 13 performs data communication with the center 35 via a wide area communication network using wireless communication. It is not necessary for all of the ECUs included in the ECU group 100 to have the communication unit 13. For example, only one or partial ECUs may be configured to have the communication unit 13.

The method for implementing the various functions of the first ECU 10 is not limited to software manner. Partial or all of the elements may be implemented using hardware circuitry. For example, when the above functions are realized by electronic circuits that are hardware, the electronic circuits may be realized by digital circuits including a large number of logic circuits, or analog circuits, or a combination of digital circuits and analog circuits.

As shown in FIG. 3, the center 35 includes a microcomputer 36, a communication unit 37, and a storage 38. The microcomputer 36 includes a CPU 36a, a ROM 36b, and a RAM 36c. The various functions of the center 35 are implemented by the CPU 36a executing a program stored in a non-transitory tangible storage medium. In the present embodiment, the ROM 36b corresponds to a non-transitory tangible storage medium storing program. A method corresponding to the program is performed when the program is executed.

The communication unit 37 performs data communication with the ECU group 100 via a wide area communication network. The storage 38 is a storage device for storing vehicle data and the like provided by the ECU group 100.

The method for implementing various functions of the center 35 is not limited to software manner. Partial or all of the elements may be implemented using hardware circuitry. For example, when the above functions are implemented by an electronic circuit configured as hardware circuitry, the electronic circuit may be implemented by a digital circuit including large number of logic circuits, an analog circuit, or a combination of digital circuit and analog circuit.

### 3. Functional Configuration

The following will describe various functions of the vehicle control system 1 with reference to FIG. 1. The vehicle control system 1 includes, as functional blocks, an equipment management unit 9 in the first layer, a state management unit 8 in the second layer, a vehicle service unit 7 in the third layer, and a service providing unit 6 in the fourth layer. The software architecture of the vehicle control system 1 is divided into above-described four layers. These layered functions of vehicle control system 1 are executed by the multiple ECUs, which are included in the ECU group 100, and the center 35.

### (3-1. Equipment Management Unit)

The equipment management unit 9 includes multiple controllers 91 to 99 corresponding to multiple types of vehicle equipment. The vehicle equipment includes, for example, a vehicle-mounted camera, a vehicle-mounted millimeter wave radar, brake, steering, display, speaker, various lights, vehicle-mounted air conditioner, electric power seat, and the like.

Specifically, the equipment management unit 9 includes a camera controller 91, a millimeter wave controller 92, a brake controller 93, a steering controller 94, a display controller 95, an audio controller 96, a light controller 97, a heating ventilation and air-conditioning (hereinafter referred to as HVAC) controller 98, and a seat controller 99. The vehicle equipment is individually controlled by a corresponding controller, which is one of the controllers 91 to 99.

A camera controller 91 controls the exposure of the vehicle-mounted camera and acquires images captured by the vehicle-mounted camera. In the present embodiment, the sixth ECU 41 includes the camera controller 91.

A millimeter wave controller 92 controls an on-board millimeter wave radar, and acquires detection results detected by the millimeter wave radar. In the present embodiment, the seventh ECU 42 includes the millimeter wave controller 92.

A brake controller 93 controls a brake. In the present embodiment, the eighth ECU 43 includes the brake controller 93.

A steering controller 94 controls steering of the vehicle. In the present embodiment, the ninth ECU 44 includes the steering controller 94.

A display controller 95 controls display devices (for example, meters, warning lights, or the like). In the present embodiment, the tenth ECU 45 includes the display controller 95.

An audio controller 96 controls a speaker to output a sound, such as warning sound or a voice. In the present embodiment, the eleventh ECU 46 includes the audio controller 96.

A light controller 97 controls various lights mounted on the vehicle. In the present embodiment, the fifth ECU 30 includes the light controller 97.

An HVAC controller 98 controls an in-vehicle air conditioner. In the present embodiment, the twelfth ECU 47 includes the HVAC controller 98.

A seat controller 99 controls an electric power seat of the vehicle. In the present embodiment, the thirteenth ECU 48 includes the seat controller 99.

The equipment management unit 9 operates the vehicle equipment in accordance with an operation instruction output from the state management unit 8, and notifies the state management unit 8 of the operation result. For example, when the vehicle equipment is an actuator, the operation result may indicate an operation of the actuator is completed normally or abnormally. When the vehicle equipment is a sensor, the operation result may indicate data detected by the sensor. When the vehicle equipment is a storage device, the notified result may include data read from the storage device.

The equipment management unit 9 may be configured to operate the vehicle equipment in accordance with an operation instruction output from the state management unit 8, as well as to automatically detect the state of vehicle equipment and notify the detected state of vehicle equipment to the state management unit 8.

### (3-2. Service Providing Unit)

The service providing unit 6 executes the application software (hereinafter referred to as applications) 61 to 64 to provide various functions, such as information collection, theft prevention, and remote control, by utilizing the vehicle equipment, which is managed by the equipment management unit 9.

In the present embodiment, the first ECU 10, the second ECU 15, and the center 35 are provided with the service providing unit 6. The ROM 11b of the first ECU 10 stores the applications 61 and 62. The ROM 11b of the second ECU 15 stores the application 63. The ROM 36b of the center 35 stores the application 64.

The applications 61 to 64 are basically configured to provide the intended services by utilizing the functions of vehicle equipment via the API unit 71, which constitutes the vehicle service unit 7.

The applications 61 to 64 each is not program for executing a process compatible with a specific vehicle type, a specific grade, or the like. The applications 61 to 64 each is a general-purpose program for executing a process compatible with different vehicle types, different vehicle grades or the like. Therefore, the applications 61 to 64 is described using functions of a modeled vehicle that is publicly available so that the applications can be developed without considering the vehicle equipment and performance of individual vehicles. The applications 61 to 64 can be easily developed by third parties who are application providers other than the OEM. Further, the developed products can be widely released. Therefore, a vehicle user who owns a vehicle equipped with the ECU group 100 can install an application released by a third party into any ECU included in the ECU group 100 via a wide area communication network or the like. The vehicle user can add or change the applications 61 to 64 as necessary.

An application may be used to provide a service that acquires vehicle information from multiple vehicles and analyzes vehicle behavior and driving operations by the driver, or the like. In this case, a service provider that provides the application may install the application in one ECU of the ECU group 100 after getting a permission of vehicle user. The access authority for accessing each API included in the API unit 71 from an application installed in the center 35 by a service provider or the like may be restricted by the vehicle user, for each service provider or for each application.

### (3-3. Vehicle Service Unit)

The vehicle service unit 7 includes an Application Programming Interface (hereinafter, API) unit 71. In the present embodiment, the API unit 71 is included in the first ECU 10. The API unit 71 includes multiple vehicle APIs. The vehicle API is an interface provided to each application 61 to 64, which is included in the service providing unit 6, for accessing the subdivided functions of the vehicle.

The vehicle API has a standardized syntax that allows requests to be written without depending on a specific vehicle type or grade. When using a function provided by the vehicle, the applications 61 to 64 each transmits a first command using the vehicle API. The first command indicates information required for using the vehicle API.

The first instruction may include a command indicating required content, an instruction such as an argument, a function call, or the like. The first command may also include priority information indicating which command should be processed with priority.

The priority may be set, for example, different in a case where the manufacturer of application, which is the request source of first command is OEM, from a case where the manufacturer of application is a third party other than the OEM. OEM is an abbreviation for original equipment manufacturer. Specifically, OEM may be set to have a higher priority than third party. Among multiple OEMs, vehicle manufacturers may be set to have a higher priority than a manufacturer of vehicle parts or a manufacturer of applications. The priority may be set according to the type of control.

The syntax of vehicle API, that is, the format of first command is written using publicly available modeled vehicle functions, similar to the applications 61 to 64, so that the vehicle API can be developed without considering the vehicle equipment and performance of individual vehicles. The first command describes the function to be executed in abstract manner without specifying the vehicle equipment or using expressions that depend on the performance of vehicle equipment. For example, the first command describes that a car finder should be turned on, but does not describe specific equipment that may be different in different vehicles. For example, the first command does not describe which vehicle equipment should be controlled and how the vehicle equipment should be controlled, such as specifying which light to turn on out of multiple lights installed in the vehicle.

When receiving the first command, the API unit 71 determines whether the first command can be accepted from a formal perspective, such as the format of first command and an access authority of request source that requests the first command. When the API unit 71 determines that the first command is acceptable, the API unit converts the first command into a second command described in a format that is compatible with the type and grade of the target vehicle. Then, the API unit sends the second command to the state management unit 8. The API unit 71 has the function of converting the first command, which is described in a standard format compatible with the service providing unit 6, into the second command, which is described in a format specific to the vehicle to be managed by the state management unit 8 and the equipment management unit 9. The second command is assigned with an application ID that identifies transmission source application of the first command (hereinafter, referred to as request application). The API unit 71 also has a function of transferring a result notification, which is a response from the state management unit 8 to the second command, to the transmission source application that has transmitted the request.

The API unit 71 includes a function API 72, a confirmation API 73, and a reservation API 74.

The function API 72 is a vehicle API that requests a control of vehicle equipment.

The confirmation API 73 is a vehicle API that confirms an available time period for the specified function API 72.

The reservation API 74 is a vehicle API that reserves the use of specified function API 72 by specifying a start condition, an end condition, or the like.

### (3-4. State Management Unit)

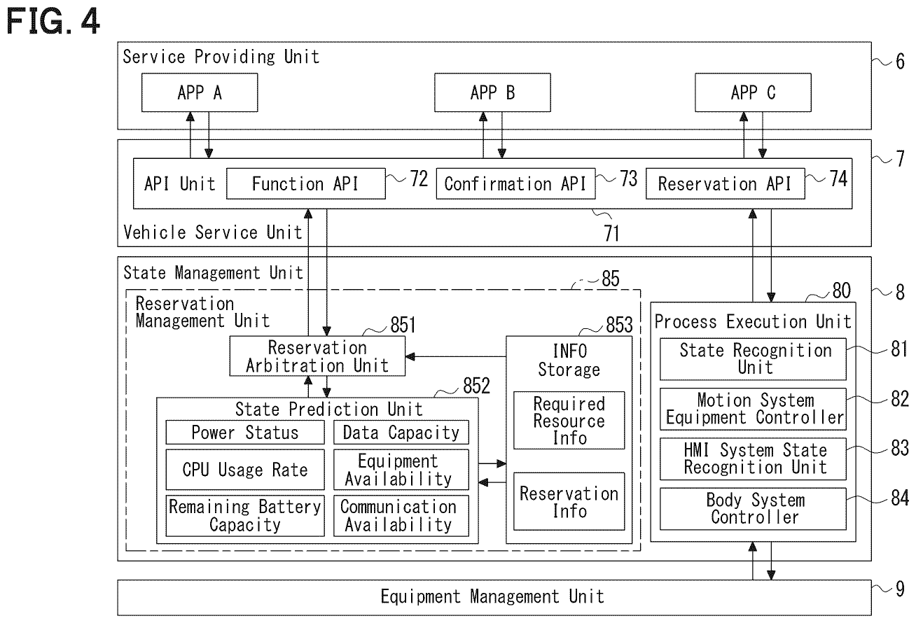

As shown in FIG. 4, the state management unit 8 includes a process execution unit 80 and a reservation management unit 85.

The process execution unit 80 processes a request from the service providing unit 6 via the function API 72.

The reservation management unit 85 processes a request from the service providing unit 6 via the confirmation API 73 and the reservation API 74.

### (3-4-1. Process Execution Unit)

The process execution unit 80 includes a state recognition unit 81, a motion system equipment controller 82, a Human Machine Interface (hereinafter referred to as HMI) system state recognition unit 83, and a body system controller 84.

The state recognition unit 81, the motion system equipment controller 82, the HMI system state recognition unit 83, and the body system controller 84 included in the process execution unit 80 are classified according to the vehicle operation that the service providing unit 6 is likely to request, rather than according to the implementation device (for example, controllers 91 to 99) that are likely to depend on vehicle variations. In the present embodiment, as shown in FIG. 1, the state recognition unit 81, the motion system equipment controller 82, the HMI system state recognition unit 83, and the body system controller 84 of the process execution unit 80 are provided in one of the first ECU 10 and the third to fifth ECU 20, 25, 30, which manage respective domains of the vehicle.

The state recognition unit 81 recognizes a state of the vehicle and a state of the surrounding of vehicle, such as the positions of vehicle and pedestrians. The state recognition unit 81 controls, for example, vehicle equipment corresponding to the camera controller 91 and the millimeter wave controller 92. In the present embodiment, the third ECU 20 includes the state recognition unit 81.

The motion system equipment controller 82 controls vehicle operation related to traveling, such as turning, traveling, and stopping. The motion system equipment controller 82 controls, for example, vehicle equipment corresponding to the brake controller 93 and the steering controller 94. In the present embodiment, the first ECU 10 includes the motion system equipment controller 82.

The HMI system state recognition unit 83 controls vehicle operation related to the presentation of information to the user. The HMI system state recognition unit 83 controls, for example, vehicle equipment corresponding to the display controller 95 and the audio controller 96. In the present embodiment, the fourth ECU 25 includes the HMI system state recognition unit 83.

The body system controller 84 controls the vehicle operation related to body system according to the vehicle environment. The body system controller 84 controls vehicle equipment corresponding to the light controller 97, the HVAC controller 98, and the seat controller 99. In the present embodiment, the fifth ECU 30 includes the body system controller 84.

When the process execution unit 80 receives a request (that is, the second command) from the vehicle service unit 7, the process execution unit determines whether the vehicle state is suitable for executing the second command. In response to determining that the vehicle state is suitable for executing the second command, the process execution unit instructs the equipment management unit 9 to operate the target equipment. The vehicle state suitable for executing the second command may include (i) the target equipment being capable of performing the function required by the second command and (ii) the execution of second command not being prohibited in a scene estimated from the vehicle state.

The process execution unit 80 has the function of outputting an operation instruction for the target equipment to the equipment management unit 9 and providing the operation result returned from the equipment management unit 9 to the vehicle service unit 7 as a result notification in response to the second command. The result notification may use the individual operation results as they are, or may integrate individual operation results and convert the integrated result into highly abstract data.

Suppose that the process execution unit 80 receives a request from the vehicle service unit 7 to collect information to specify the vehicle state. In this case, the process execution unit obtains data from multiple vehicle equipment, as the operation result of equipment management unit 9. When data such as “vehicle speed 0 km/h,” “shift position P,” and “driver not in the vehicle” are acquired as the operation result, the multiple piece of data may be converted into data indicating that “vehicle in parked state,” and the converted data may be sent to the vehicle service unit 7 as the result notification.

### (3-4-2. Reservation Management Unit)

The reservation management unit 85 is provided in the first ECU 10. Alternatively, the reservation management unit 85 may be provided in another ECU rather than the first ECU 10. As shown in FIG. 4, the reservation management unit 85 includes a reservation arbitration unit 851, a state prediction unit 852, and an information storage 853.

The information storage 853 stores required resource information and reservation information.

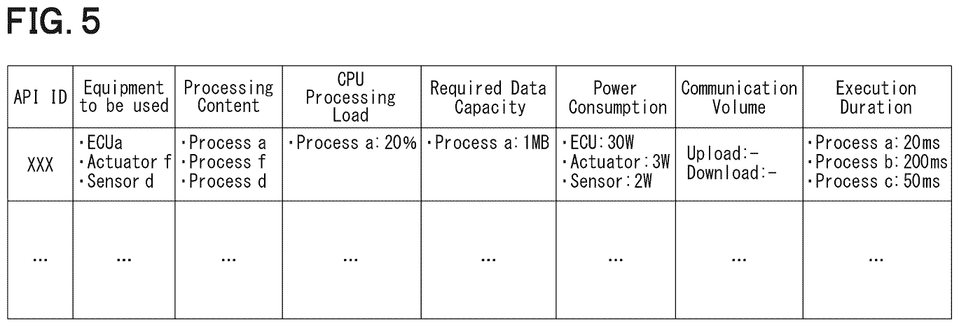

The required resource information is information that associates an API_ID that identifies a function API 72 with a resource required to execute a process associated with the corresponding function API 72. Specifically, as shown in FIG. 5, the resource required to execute the process include information such as “equipment to be used,” “processing content,” “CPU processing load,” “required data capacity,” “power consumption,” “communication volume,” and “execution duration.”

The “equipment to be used” indicates an ECU that executes the process, an actuator or a sensor that corresponds to a processing target. “Processing content” indicates the processing required for each piece of equipment used. The “CPU processing load” indicates a processing load of the ECU included in the “equipment to be used.” The “required data capacity” indicates free memory capacity required for executing a process in the ECU included in the “equipment to be used”. The “power consumption” indicates a power consumption of each piece of equipment included in “equipment to be used.” The “communication volume” indicates the communication volume required for uploading data and the communication volume required for downloading data when communication with an external server is required. The “execution duration” indicates an average processing duration of each process included in the “processing content.”

The reservation information is information related to use reservation of function API 72. The reservation information is set in accordance with a request from the service providing unit 6, which uses the reservation API 74. The reservation information includes the function API 72 that identifies the reservation target function API 72, an application ID of an application that requests the reservation, start time and end time of reservation, and the like.

In response to an inquiry from the reservation arbitration unit 851, the state prediction unit 852 responds a predicted usage state of the vehicle equipment (that is, resource). The target period of prediction may be set to a specified time range (for example, 24 hours) from the time when the request is accepted, or the target period of prediction may be set to a time range specified by the instruction from the reservation arbitration unit 851.

The resource to be predicted may include “power supply status,” “CPU usage rate,” “remaining battery capacity,” “free data capacity,” “equipment availability,” “communication availability,” or the like.

The “power supply status” may include information indicating whether the IG is in ON, ACC, or OFF state, as well as information indicating a connection state of charging plug. The “CPU usage rate” indicates usage rate of target CPU installed in the first ECU 10. The target CPU is the CPU that executes the process corresponding to the vehicle service unit 7 and the process corresponding to the reservation management unit 85 of the state management unit 8. The CPU usage rate is expressed as a percentage. The “CPU usage rate” may further include information on the usage rate of CPU installed in other ECUs different from the first ECU 10. The “remaining battery capacity” indicates the remaining capacity of the vehicle battery in percentage. The “free data capacity” indicates the free memory capacity available for processing. The “equipment availability” indicates a result of determination whether the equipment is available for use. Whether the equipment is available for use may include whether the equipment has an anomaly or whether the equipment is in operation state or not. The equipment for which “equipment availability” is indicated may be configured to perform high load processing, such as an image processing. The “communication availability” indicates a communication status with an external server. For example, an occupancy rate of a communication channel used for the communication with the external server may be indicated for each application.

The state prediction unit 852 repeatedly acquires the state of vehicle-mounted equipment from the equipment management unit 9 and accumulates the results in a predetermined aggregation method. The aggregation method may count the elapsed period from the start time point, which is the time when the IG switch of the vehicle is turned on or off, as an index. The aggregation value may be calculated individually for each day of the week, each season, each driver, each traveling route, or each destination. The traveling route may include, for example, a commute route and routes other than the commute route.

When the state prediction unit 852 receives an inquiry from the reservation arbitration unit 851, the state prediction unit predicts the usage state of each resource and returns the prediction result to the reservation arbitration unit 851. The usage state of each resource is predicted with consideration of the aggregated value of past usage state and reservation information stored in the information storage 853. The usage state of each resource may be predicted using information, such as whether each application has access right to each API, a traveling route set by the navigation device, and estimated time of arrival. Prediction of usage state for each resource may use information, such as predicted alighting extracted from images captured by a camera that captures images inside the vehicle compartment, or information about the driver's schedule obtained by linking with the calendar on a mobile terminal of the driver.

The following will describe a method for predicting the usage state of source by the state prediction unit 852.

For the “power supply status,” when the current power supply status is IG-ON or the charging plug is in connected state, the probability that the current power status is IG-ON is set to 100%, and the predicted value S1 is gradually reduced with elapse of time.

There are two methods for reducing the predicted value S1. First is a method for simply reducing the predicted value in inverse proportion to the elapse of time, as shown in mathematical formula (1). Second is a method for reducing the predicted value in accordance with a preset first table value f1(t), as shown in mathematical formula (2). In the formulas, t represents time, and f1(t) takes a value within a range of 0 to 1. f1(t) is set such that the value changes with the elapse of time.

S1[%]=100/t (1)

S1[%]=100×f1(t) (2)

The first table value f1(t) may be set based on past history. In this case, the first table value f1(t) may be set to monotonically decrease over a calculated average time until the value of first table value f1(t) reaches almost zero. The average time may be calculated, based on the past history, from when the IG is turned on until when the IG is turned off.

When the current power supply status is IG-ON and the traveling route is set by the navigation device, the first table value f1(t) may be set as follows. The first table value f1(t) may be set to a relatively small value up to the estimated arrival time in the route guidance executed by the navigation device, and to a larger value, which is larger than the value set until the estimated arrival time, after the estimated arrival time.

When the current power supply status corresponds to that the charging plug is in connected state, the first table value f1(t) may be set to a small value until the scheduled charging completion time according to the charging plan, and to a large value after the scheduled charging completion time.

The predicted value S2 of “CPU usage rate” may be calculated according to mathematical formula (3) using a second table value f2 (t). The second table value represents the CPU usage rate predicted from the application usage record or the application usage plan. The second table value f2 (t) takes a value within a range of 0 to 1.

S2[%]=100×f2(t) (3)

When setting the second table value f2 (t) from the usage history of application, the usage history of application is aggregated on a time axis representing the elapsed time from the time when IG was turned ON, and the probability that each application will be used at a specific time is calculated. The second table value f2 (t) is set based on this probability and the CPU usage rate when each application is used. The second table value f2 (t) may be set individually for each application.

The second table value f2 (t) may be set using an application usage plan instead of the actual application usage record.

The predicted value S3 of “remaining battery capacity” may be calculated according to a mathematical formula (4) using the current remaining battery capacity Qc[%] as a reference and using a third table value f3(t). The third table value f3(t) is set based on the application usage history or application usage plan and the power consumption required by each application.

S3[%]=Qc−100×f3(t) (4)

The third table value f3(t) is set such that the amount of attenuation increases (i) as the probability that an application will be used at each time point increases or (ii) as the power consumption of application increases. When the traveling route is set by the navigation device, the third table value f3(t) may be set in consideration of the usage state of application predicted from the traveling route.

The predicted value S4 of “free data capacity” may be calculated according to the mathematical formula (5) using a fourth table value f4(t). The fourth table value f4(t) is set based on the (i) application usage history or usage plan and (ii) the data capacity required by each application when executing a process, with the maximum value of available data capacity being Dm.

S4[%]=Dm×f4(t) (5)

The fourth table value f4(t) is set based on the probability of each application being used at each time point and the data capacity required when each application is executed. The probability of each application being used at each time point is calculated from the aggregation result of application usage recorded on a time axis representing the elapsed time starting from the time when the IG was turned ON. Instead of the actual usage record of application, a usage plan of application may be used in setting of the fourth table value.

The predicted values S5 and S6 of “equipment availability” may be calculated, respectively, using a fifth table value f5 (t) and a sixth table value f6 (t). The fifth table value f5 (t) and the sixth table value f6 (t) are set based on the usage history or usage plan of equipment that may be accessed by multiple applications (for example, camera, special image processing, or the like). The predicted value S5 indicates a probability that the equipment is not in use and available, and may be calculated according to the mathematical formula (6). The predicted value S6 indicates a probability that the equipment is in use and is not available, and may be calculated according to the mathematical formula (7).

S5[%]=100×f5(t) (6)

S6[%]=100×f6(t) (7)

The predicted value S7 of “communication availability” may be calculated using the mathematical formula (8) with the current communication state as C [%]. The predicted value S7 may also be calculated using the mathematical formula (9) with the seventh table value f7 (t) representing the communication state estimated from the vehicle's traveling plan. The current communication state C may be, for example, the ratio of actually measured communication speed to the maximum communication speed. The seventh table value f7 (t) takes a value within a range of 0 to 1.

S7[%]=C/t (8)

S7[%]=100×f7(t) (9)

When the traveling route is set by the navigation device, the seventh table value f7 (t) may be set to a smaller value depending on the surrounding environment of the traveling route, for example, at the scheduled time of passing through a tunnel or a group of buildings, where the communication conditions is estimated to deteriorate.

The first to seventh table values f1(t) to f7 (t) may be prepared individually for each season, each time period, or each driver.

The reservation arbitration unit 851 executes a reservation arbitration process for processing a request transmitted from the service providing unit 6 via the confirmation API 73 or the reservation API 74 of the API unit 71.

### 4. Process

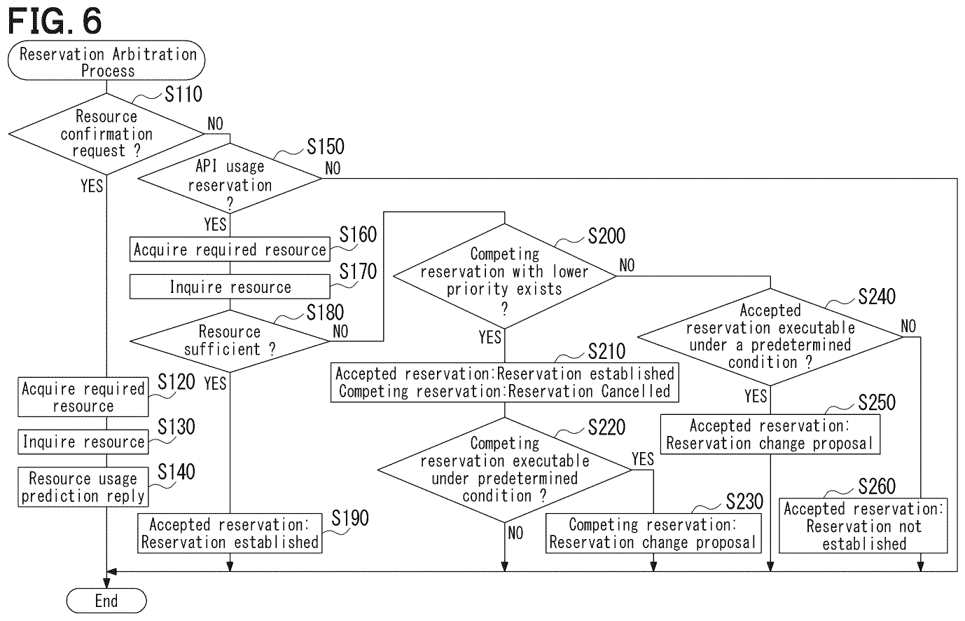

The reservation arbitration process executed by the reservation arbitration unit 851 will be described with reference to the flowchart of FIG. 6. The reservation arbitration process starts in response to receiving a second command from the vehicle service unit 7.

When the reservation arbitration process starts, in S110, the reservation arbitration unit 851 determines whether the received second command is a “resource confirmation” request. The “resource confirmation” request is a request input via the confirmation API 73. The “resource confirmation” request includes an application ID, which identifies the request source application, and an API_ID, which is identification information for identifying the function API 72 to be used (hereinafter referred to as confirmation target API). The “resource confirmation” request may further include information specifying the time period to be predicted.

When the reservation arbitration unit 851 determines that the received second command is a “resource confirmation” request, the process proceeds to S120. When the reservation arbitration unit 851 determines that the received second command is not a “resource confirmation” request, the process proceeds to S150.

In S120, the reservation arbitration unit 851 refers to the required resource information stored in the information storage 853 and acquires information about the resource required to execute the confirmation target API (hereinafter referred to as required resource).

In S130, the reservation arbitration unit 851 inquires of the state prediction unit 852 and obtains resource usage prediction. The resource usage prediction indicates, for each resource, fluctuation in the resource usage prediction during a predetermined time period. When time period is specified in the “resource confirmation” request, the time period of resource usage prediction is set according to the time period specified in the resource confirmation request. When time period is not specified in the “resource confirmation” request, the usage prediction is displayed for a certain time period (for example, 24 hours) from the current time.

In S140, the reservation arbitration unit 851 generates a “resource prediction reply” notification in accordance with the information regarding the required resource acquired in S120 and the resource usage prediction acquired in S130, and sends the reply to the request source application via the API unit 71, thereby completing the process. The “resource prediction reply” notification includes an API_ID, which is identification information for identifying the confirmation target API, and start time and end time of the time period during which the confirmation target API can be used (hereinafter referred to as available time period). The available time period is extracted under the condition that the available amount of resource estimated from the resource usage prediction has a surplus over the amount of resource required by the confirmation target API, and the surplus is required to be equal to or greater than a predetermined lower limit. There may be multiple available time periods. The “resource prediction replay” notification may include the probability (hereinafter referred to as “available probability”) that the confirmation target API can actually be used during the available time period and the resource usage prediction obtained in S130. The information indicating the available time period, the probability of availability, and the resource usage prediction added to the “resource prediction reply” notification correspond to reference information of the present disclosure.

In S150, the reservation arbitration unit 851 determines whether the received second command is an “API usage reservation” request. The “API use reservation” request is a request input via the reservation API 74. The “API usage reservation” request includes an application ID that identifies the request source application, an API_ID that identifies the function API 72 to be reserved (hereinafter referred to as reservation target API), and usage information indicating the usage condition of reservation target API. The usage information includes at least usage time period information that specifies the usage time period of reservation target API. The usage time period information includes a start condition for starting use of the reservation target API and an end condition for ending use of the reservation target API. The start condition and the end condition each may be a specific time, or an occurrence of event, such as detection of IG-ON or arrival at a destination. The end condition may be set as a period of time has elapsed from the start of use. The usage information may optionally include information specifying the resource to be used (hereinafter referred to as “specified resource”). The specified resource may include, for example, an upper limit time period allowed for communication with an external server, such as the center 35.

When the reservation arbitration unit 851 determines that the second command is an “API usage reservation” request, the process proceeds to S160. When the reservation arbitration unit 851 determines that the second command is not an “API usage reservation” request, the process is ended.

In S160, the reservation arbitration unit 851 acquires information about the resource required by the reservation target API in the same manner as in S120. At this time, when the start condition and end condition of the usage time period information are not set as specific time points, a processing is carried out for converting the start condition into a specific start time and converting the end condition into a specific end time.

In S170, the reservation arbitration unit 851 obtains a resource usage prediction in the same manner as in S130.

In S180, the reservation arbitration unit 851 determines whether the resource required to execute the reservation target API can be prepared for the usage time period indicated by the usage time period information, that is, whether the resource is sufficient. Specifically, when the available amount of resource identified from the resource usage prediction obtained in S170 is greater than the required amount of resource by the reservation target API obtained in S160 throughout the entire usage time period, the reservation arbitration unit determines that the resource is sufficient. That is, whether or not the reservation target API can be executed is determined depending on whether the resource is sufficient or not.

When the reservation arbitration unit 851 determines that there is sufficient resource to execute the reservation target API throughout the usage time period, the process proceeds to S190. When the reservation arbitration unit 851 determines that the resource to execute the reservation target API is not sufficient, the process proceeds to S200.

In S190, the reservation arbitration unit 851 sends a “reservation established” notification, which indicates that the usage reservation (hereinafter referred to as the acceptance reservation) in response to the “API usage reservation” request has been established, to the request source application, which has requested the acceptance reservation, via the API unit 71. The reservation arbitration unit 851 stores reservation information indicating the content of established reservation in the information storage 853, and ends the process. The “reservation established” notification includes API_ID of reservation target API, reservation start time, reservation end time, and the like. The reservation information stored in the information storage 853 is reflected in the prediction of resource usage state performed by the state prediction unit 852.

In S200, the reservation arbitration unit 851 determines whether there is a competing reservation, which is a usage reservation with a lower priority than the accepted reservation, among the reservation information stored in the information storage 853. A competing reservation is another reservation that has already been established and whose usage time period overlaps with the accepted reservation. The priority may be assigned to the request source application, the reservation target API, the manufacturer of application, or whether the application is installed in the vehicle or an external server. The shorter the reservation time period, the higher the priority may be. The priority may be differentiated depending on whether there is fee charging and the grade of charging fee.

When there is a competing reservation with a lower priority than the accepted reservation, the reservation arbitration unit 851 proceeds to S210. When there is no competing reservation with a lower priority, the reservation arbitration unit 851 proceeds to S240.

In S210, the reservation arbitration unit 851 sends a “reservation established” notification to the request source application of the accepted reservation via the API unit 71. The reservation arbitration unit 851 sends a “reservation cancellation” notification to the request source application of competing reservation (hereinafter referred to as a competing application) via the API unit 71. The “reservation cancellation” notification indicates details of the cancelled reservation. The “reservation cancellation” notification may also indicate the reason why the reservation is cancelled. The reservation arbitration unit 851 stores reservation information indicating the content of established reservation in the information storage 853, and deletes reservation information about the competing reservation from the information storage 853.

In S220, when the accepted reservation that has established is executed, the reservation arbitration unit 851 determines whether the competing reservation can be executed under a predetermined condition. In response to determining that the competing reservation can be executed under a predetermined condition, the process proceeds to S230. In response to determining that the competing reservation cannot be executed even under a predetermined condition, the process is ended. The predetermined condition under which the competing reservation can be executed may include a case where execution is possible if the time period is changed, a case where execution is possible if an amount of resource usage per unit time is decreased thereby allowing for an increase in execution time required for processing. The amount of resource usage may include the amount of CPU usage, the amount of communication volume with the center 35, and the like.

In S230, the reservation arbitration unit 851 transmits a “reservation change proposal” notification to the competing application via the API unit 71. The “reservation change proposal” notification includes the API_ID of reservation target API, the application ID of request source application, and the contents of reservation change proposal. The proposed contents may include an available time period for change, and start time and end time after change when the use of resource is restricted.

Based on the contents of received “reservation change proposal” notification, the competing application may send an “API usage reservation” request that indicates the reservation change proposal is accepted.

In S240, the reservation arbitration unit 851 determines whether the accepted reservation can be executed under a predetermined condition. In response to determining that the accepted reservation can be executed under the predetermined condition, the process proceeds to S250. In response to determining that the accepted reservation cannot be executed even under the predetermined condition, the process proceeds to S260. The determination of whether the accepted reservation can be executed under the predetermined condition is similar to the process in S220.

In S250, the reservation arbitration unit 851 transmits a “reservation change proposal” notification to the request source application of the reservation request, and ends the process.

In S260, the reservation arbitration unit 851 transmits a “reservation not established” notification to the request source application of the reservation request, and ends the process. The “reservation not established” notification includes the API_ID of reservation target API and the application ID of request source application. The “reservation not established” notification may include information indicating the reason for reservation failure.

The following will describe an example of the contents of reservation change proposal in a case where executing the reserved API under the condition specified in the “API usage reservation” request as requested by the request source application may result an insufficiency in the CPU usage, communication volume, or data capacity, making it impossible to execute the reserved API as requested.

For example, when the condition specified in the “API usage reservation” requests an instruction of image capturing, image processing, and image upload once per second and continue for five consecutive minutes, the API usage reservation may be changed to increase the image capturing interval to a longer interval (for example, once per two seconds). At this time, the length of usage time period of reservation target API may be changed in accordance with the change in the image capturing interval.

When the condition indicated in the “API usage reservation” request is download of data via wireless communication (for example, OTA) in five minutes, increase of allowable download duration (for example, one hour) may be proposed.

### 5. Operation

### (5-1. Basic Operation)

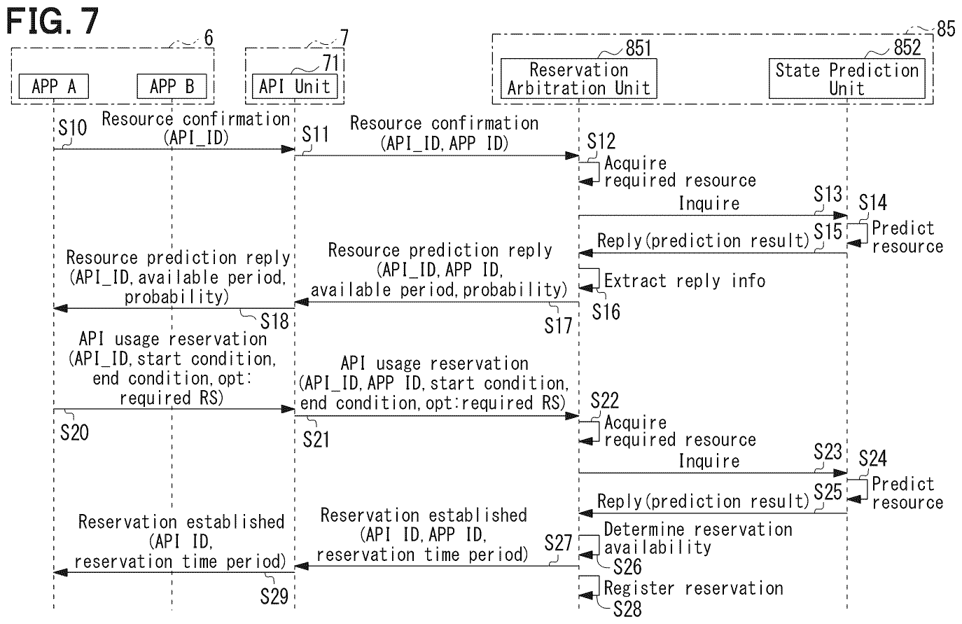

The following will describe a basic operation of the vehicle control system 1 with reference to the sequence diagram of FIG. 7.

As shown in FIG. 7, in S10, the application A included in the service providing unit 6 sends a “resource confirmation” request as the first command to the API unit 71 of the vehicle service unit 7 using the confirmation API 73.

The API unit 71 performs a format check and an authority check on the received “resource confirmation” request. In response to determining that the format and authority are valid, the API unit converts the “resource confirmation” request from the first command format to the second command format. Then, in S11, the API unit 71 transmits the “resource confirmation” request converted into the second command format to the reservation arbitration unit 851 of the state management unit 8.

When the reservation arbitration unit 851 receives the “resource confirmation” request converted into the second command, in S12, the reservation arbitration unit acquires, from the information storage 853, the required resource for the confirmation target API, which is identified from the API_ID indicated in the “resource confirmation” request. The reservation arbitration unit 851 further transmits an “inquiry” to the state prediction unit 852 in S13.

When the state prediction unit 852 receives the “inquiry” from the reservation arbitration unit 851, the state prediction unit predicts the resource usage state in S14, and returns a “reply” indicating the prediction result to the reservation arbitration unit 851 in S15.

When the reservation arbitration unit 851 receives, from the state prediction unit 852, the “reply” to the “inquiry”, in S16, the reservation arbitration unit 851 extracts the available time period, which is information to be sent to the request source application, based on the prediction result indicated in the “reply” and the required resource acquired in S12. In S17, the reservation arbitration unit 851 transmits a “resource prediction reply” notification indicating the information extracted in S16 to the API unit 71.

In S18, the API unit 71 transmits the “resource prediction reply” notification received from the reservation arbitration unit 851 to the application A, which is the request source application of the “resource confirmation” request.

In S20, the application A uses the reservation API 74 to send an “API usage reservation” request to the API unit 71 as the first command. The contents of “API usage reservation” request may be set in consideration of the information indicated in the “resource prediction reply” notification, or may be set independently of the “resource prediction reply” notification.

When the API unit 71 receives the “API usage reservation” request, in S21, the API unit 71 performs a format check and an authority check, similar to check made on the “resource confirmation” request. When the check result indicates that the format check and authority check succeeded, the “API usage reservation” request is converted from the first command format to the second command format and sent to the reservation arbitration unit 851.

When the reservation arbitration unit 851 receives the “API usage reservation” request, in S22, the reservation arbitration unit 22 acquires, from the information storage 853, the required resource of the reservation target API, which is specified by the API_ID indicated in the “API usage reservation” request. The reservation arbitration unit 851 further transmits an “inquiry” to the state prediction unit 852 in S23.

When the state prediction unit 852 receives an “inquiry” from the reservation arbitration unit 851, the state prediction unit 852 predicts the resource usage state in S24, and returns a “reply” indicating the prediction result, to the reservation arbitration unit 851 in S25.

When the reservation arbitration unit 851 receives a “reply” to the “inquiry” from the state prediction unit 852, the reservation arbitration unit 851 determines, in S26, whether the reservation can be accepted. Whether the reservation can be accepted is determined based on the prediction result indicated in the “reply”, the start and end conditions indicated in the “API usage reservation” request, and the required resource acquired in S22.

As a result of determining whether the reservation can be accepted, in response to determining that the reservation target API can be executed under the start and end conditions specified in the “API usage reservation” request, the reservation arbitration unit 851 sends a “reservation established” notification to the API unit 71. The reservation arbitration unit 851 further stores reservation information indicating the contents of the established reservation in the information storage 853.

In S29, the API unit 71 transmits the “reservation established” notification received from the reservation arbitration unit 851 to application A, which is the request source application of the “API usage reservation” request.

(5-2. Operation Executed when Reservation Competition Occurs)

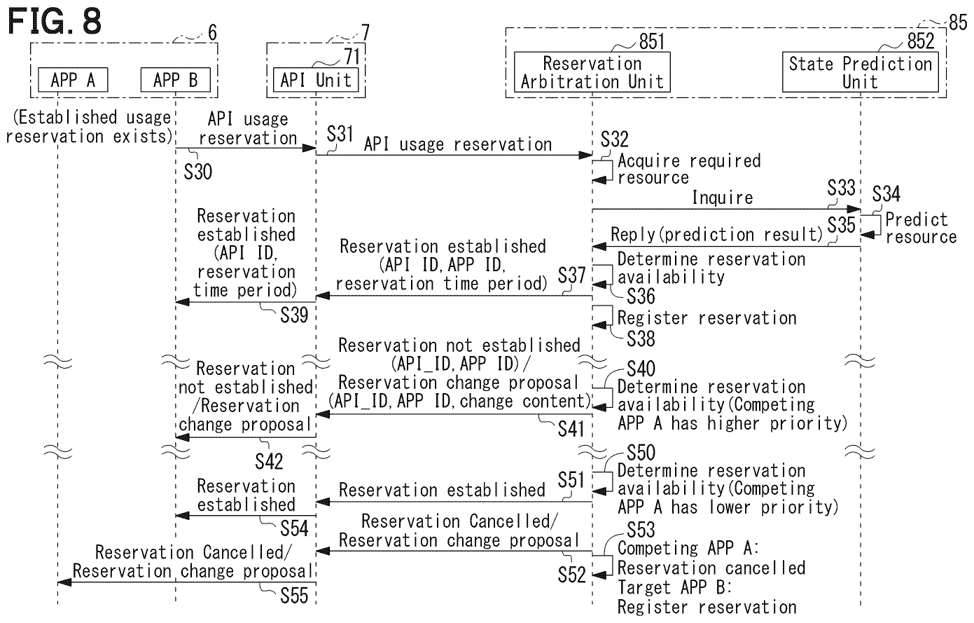

The following will describe an operation executed when a competing reservation exists in reservation availability determination with reference to FIG. 8. Suppose that the application A has an established usage reservation, and the application B sends an “API usage reservation” request to the API unit 71 to use the same resource as the resource requested by the usage reservation made by the application A.

The following will describe a case where the usage reservation made by the application B can be executed regardless of the usage reservation made by the application A.

As shown in FIG. 8, in S30, the application B sends an “API usage reservation” request. Thereafter, the process in S32 to S38 performed by the API unit 71, the reservation arbitration unit 851, and the state prediction unit 852 are the same as the process executed in S22 to S28 of FIG. 7.

In S36, if the resource is sufficient even when the competing application A is executed at the same time as the application B, the reservation request from the application B is determined to be acceptable. In S38, the reservation arbitration unit 851 stores, in the information storage 853, reservation information indicating the details of reservation made by the “API usage reservation” request from application B.

In S39, the API unit 71 transmits the “reservation established” notification received from the reservation arbitration unit 851 to the application B, which is the request source application of the “API usage reservation” request.

The following will describe a case where the usage reservation made by the application A has a higher priority than the usage reservation made by the application B.

The process executed in S30 to S35 are the same as those explained above, so the detailed explanation will be omitted and only the process after S35 will be explained.

When the reservation arbitration unit 851 receives a “reply” to the “inquiry” from the state prediction unit 852, the reservation arbitration unit determines, in S40, whether the reservation can be accepted. The availability of reservation is determined based on the prediction result indicated in the “reply”, the start and end conditions indicated in the “API usage reservation” request, and the required resource acquired in S32. In this case, it is determined that the reservation cannot be made under the conditions specified in the “API usage reservation” request from the application B, and the reservation arbitration unit 851 sends a “reservation not established” notification or a “reservation change proposal” notification to the API unit 71 in S41. The “reservation change proposal” notification is sent when the reservation can be accepted if the reservation details are changed. The “reservation not established” notification is sent when the reservation cannot be accepted even if the reservation details are changed.

In S42, the API unit 71 transmits the “reservation not established” notification or the “reservation change proposal” notification received from the reservation arbitration unit 851 to the application B, which is the request source application of the “API usage reservation” request.

The following will describe a case where the usage reservation made by the application A has a lower priority than the usage reservation made by the application B.

The process executed in S30 to S35 are the same as those explained above, so the detailed explanation will be omitted and only the process after S35 will be explained.

When the reservation arbitration unit 851 receives a “reply” to the “inquiry” from the state prediction unit 852, the reservation arbitration unit determines, in S50, whether the reservation can be accepted. The availability of reservation is determined based on the prediction result indicated in the “reply”, the start and end conditions indicated in the “API usage reservation” request, and the required resource acquired in S32. In this case, the reservation is determined to be acceptable under the condition indicated in the “API usage reservation” request from the application B. In S51, the reservation arbitration unit 851 transmits, to the API unit 71, the “reservation established” notification destined for the application B. In S52, the reservation arbitration unit 851 transmits, to the API unit 71, the “reservation cancellation” notification destined for the application A. When the usage reservation from the application A can be accepted if the conditions are changed, the “reservation change proposal” notification indicating the changes is sent in addition to the “reservation cancellation” notification. Instead of sending the “reservation change proposal” notification, information about the changes indicated in the “reservation change proposal” notification may be added to the “reservation cancellation” notification.

In S53, the reservation arbitration unit 851 deletes the reservation information of the application A from the information storage 853, and stores the reservation information of the application B in the information storage 853.

In S54, the API unit 71 transmits the “reservation established” notification received from the reservation arbitration unit 851 to the application B, which is the request source application of the “API usage reservation” request. In S55, the API unit 71 transmits the “reservation cancellation” notification and the “reservation change proposal” notification to the competing application, that is, the application A.

### 6. Correspondence of Terms

In the present embodiment, the reservation arbitration unit 851 that executes the process in S120 to S140 corresponds to information generation unit of the present disclosure. The confirmation API 73 corresponds to information providing unit of the present disclosure, and the center 35 corresponds to an external device of the present disclosure. In the present embodiment, the reservation arbitration unit 851 that executes the process in S160 corresponds to required amount acquisition unit, the reservation arbitration unit 851 that executes the process in S170 to S260 corresponds to reservation availability determination unit, and the reservation arbitration unit 851 that executes the process in S220 and S250 corresponds to change proposal unit.

### 7. Effects

The above-described present embodiment can provide the following effects.
(1) The vehicle control system 1 includes the confirmation API 73 that is used by each of the applications 61 to 64 included in the service providing unit 6, and the confirmation API 73 confirms, for each application, the available time period of specific API. Therefore, each of the applications 61 to 64 can select a time period that does not compete with other applications and execute a control using the necessary API. In a use case where each of the multiple applications 61 to 64 (that is, multiple systems inside and outside the vehicle) arbitrarily accesses a resource, it is possible to suppress competition occurred in multiple access requests. Further, it is possible to suppress a situation in which resource become insufficient due to multiple competing access requests.
(2) The “resource prediction reply” notification returned in response to the “resource confirmation” request using the confirmation API 73 probabilistically indicates the predicted result of usage state for each resource. Therefore, the application can flexibly determine the execution time of API according to the notified prediction result.
(3) The vehicle control system 1 includes the reservation API 74 that is used by each of the applications 61 to 64, which is included in the service providing unit 6, to reserve resource required to execute a specified API. Therefore, even if there are multiple applications that operate independently from one another, each application can execute own processing as scheduled because resource is secured for the reserved time period.
(4) The reservation details of established reservation made by the reservation API 74 are reflected when predicting the resource usage state, thereby improving the accuracy of predicting the resource usage state.
(5) When processing the “API usage reservation” request, if there is a competition usage reservations and if executing both of the accepted usage reservation and the competition usage reservations would result in a shortage of resource, the request with the higher priority is accepted and the reservation change proposal is made for the request with the lower priority. The reservation change proposal includes change of time period and limiting of resource use. Therefore, the high priority request can be reliably executed, and the lower priority request can easily and quickly change the execution schedule in accordance with the reservation change proposal.

### 8. Other Embodiments

Although the embodiments of the present disclosure have been described above, the present disclosure is not limited to the above embodiments, and various modifications can be made.
(a) In the above embodiment, the vehicle service unit 7 converts the first command into the second command. Alternatively, the state management unit 8 may convert the first command into the second command.
(b) In the above embodiment, the reasons for incompatibility were exemplified as “format incompatibility,” “authority incompatibility,” “equipment incompatibility,” and “scene incompatibility,” but other reasons may also be included, such as “priority incompatibility” and “communication timeout.” If the reason for incompatibility is “priority incompatibility,” the suggestion information may indicate the priority level at which the system is determined to be compliant.
(c) In the above embodiment, the reference information to be added to the “resource prediction reply” notification is generated each time the “resource confirmation” request is received. As another example, in the above embodiment, the reference information may be prepared in advance by periodically generating the reference information, and this previously prepared reference information may be added to the “resource prediction reply” notification.
(d) In the above embodiment, each of the applications 61 to 64 is configured to acquire the reference information via the confirmation API 73. As another example, the reference information may be provided by storing the reference information in a shared memory that can be accessed from each of the applications 61 to 64. Instead of using the confirmation API 73 included in the API unit 71, the reference information may be provided using an API provided in each of the applications 61 to 64.
(e) In the above embodiment, the first ECU 10, the second ECU 15, and the center 35 each is provided with the service providing unit 6. The first ECU 10 is provided with the vehicle service unit 7. The first ECU 10, the third ECU 20, the fourth ECU 25, and the fifth ECU 30 each is provided with the state management unit 8. The fifth ECU 30 to the thirteenth ECU 48 each is provided with the equipment management unit 9. The number of ECUs belonging to the ECU group 100 and the way in which the functions of service providing unit 6, vehicle service unit 7, state management unit 8 and equipment management unit 9 are allocated to each ECU are not limited to the example described in the embodiment, that is, may be properly arranged in a different way.
(f) The multiple functions of one component in the above embodiments may be implemented by multiple components, or a function of one component may be implemented by multiple components. Multiple functions of multiple elements may be implemented by one component, or a single function implemented by multiple components may be implemented by one component. In the above embodiment, a part of the configuration may be properly omitted. At least a part of the configuration of the above embodiment may be added to or substituted for the configuration of other embodiments.
(g) In addition to the vehicle control device described above, the present disclosure can be implemented in various forms, such as a program for causing a computer to function as a vehicle control device, a non-transitory tangible storage medium such as a semiconductor memory in which this program is stored, and a vehicle control method.

What is claimed is:

1. A vehicle control device mounted on a vehicle, the vehicle control device comprising at least one processor with a memory storing computer program code, wherein the at least one processor with the memory is configured to implement:
an equipment management unit configured to control vehicle equipment, which is equipped to the vehicle, and manage a state of the vehicle equipment;
an application programming interface (API) unit having multiple function APIs, wherein the multiple function APIs are interfaces to respectively implement multiple functions using the vehicle equipment, each function API receives a request transmitted from an application software and provides the corresponding function using the vehicle equipment that is managed by the equipment management unit;
a state prediction unit configured to predict a state of resource included in the vehicle for a specified time period;
an information generation unit configured to generate, for each function API, reference information, which includes a time period during which the corresponding function API can be used, based on a prediction result by the state prediction unit; and
an information providing unit configured to provide the reference information generated by the information generation unit to the function API specified in the request transmitted from the application software.

2. The vehicle control device according to claim 1, wherein
the resource to be predicted by the state prediction unit includes at least one of (i) a power supply status of the vehicle, (ii) a usage rate of central processing unit that executes a processing related to each function API, (iii) a remaining capacity of a battery mounted on the vehicle, (iv) an availability of the vehicle equipment corresponding to a control target, or (v) a communication availability with an external device located outside the vehicle.

3. The vehicle control device according to claim 1, wherein
the reference information indicates an availability of each function API using a probability that changes over time.

4. The vehicle control device according to claim 1, wherein
the API unit further includes a reservation API that accepts a usage reservation for one of the multiple function APIs,
the usage reservation includes identification information for identifying a reservation target API, which is the function API to be reserved among the multiple function APIs, and usage information indicating a usage condition of the reservation target API, and
the at least one processor with the memory is configured to implement:
a required amount acquisition unit configured to acquire a required amount of the resource for executing the usage reservation based on the identification information; and
a reservation availability determination unit configured to determine whether the usage reservation can be executed under the usage condition indicated by the usage information based on the prediction result by the state prediction unit and an acquisition result by the required amount acquisition unit, the reservation availability determination unit further notifying a determination result to a request source of the usage reservation.

5. The vehicle control device according to claim 4, wherein
the usage condition includes at least one of (i) a specified usage time period during which the reservation target API is to be used or (ii) a specified upper limit time period required for a processing that uses the reservation target API.

6. The vehicle control device according to claim 4, wherein
the usage reservation includes information indicating a priority of reservation,
when a competing reservation, which has a priority lower than a priority of an accepted reservation exists and the accepted reservation can be executed by canceling the competing reservation, the reservation availability determination unit is configured to cancel the competing reservation having the lower priority than the accepted reservation and determine that the accepted reservation can be executed,
the accepted reservation is the usage reservation accepted by the reservation API, and
the competing reservation having the lower priority than the accepted reservation is a usage reservation that has been established and uses same resource as the accepted reservation.

7. The vehicle control device according to claim 4, wherein
the state prediction unit is configured to, for the usage reservation that has been established, reflect the required amount of the resource acquired by the required amount acquisition unit in the prediction result.

8. The vehicle control device according to claim 4, wherein
the at least one processor with the memory is configured to implement a change proposal unit configured to notify, to the request source of the usage reservation, a reservation change proposal indicating an executable usage condition when the usage reservation has been determined, by the reservation availability determination unit, to be not executable under the usage condition but can be executed by changing the usage condition.

9. The vehicle control device according to claim 1, wherein
the information providing unit is configured to provide the reference information to the application software via a confirmation API included in the API unit.

10. A vehicle control method executed by at least one processor of a vehicle control device mounted on a vehicle, the vehicle control method comprising:
controlling vehicle equipment equipped to the vehicle and managing a state of the vehicle equipment;
implementing, using the at least one processor, an application programming interface (API) unit including multiple function APIs, wherein the multiple function APIs are interfaces to respectively perform multiple functions using the vehicle equipment, and each function API receives a request transmitted from an application software and provides the corresponding function using the vehicle equipment;
predicting a state of resource included in the vehicle for a specified time period;
generating, for each function API, reference information, which includes a time period during which the corresponding function API can be used, based on the predicted state of resource; and
providing the generated reference information to the function API specified in the request transmitted from the application software.
